(19) United States
(12) Patent Application Publication
(10) Pub. No.: US 2020/0029580 A1
(43) Pub. Date: Jan. 30, 2020

(54) I-C-AW Program Cycle-Controlled Operation Of A Portioning Drum For A Dough Portioning And Kneading Machine

(71) Applicant: König Maschinen Gesellschaft m.b.H, Graz (AT)

(72) Inventors: Robert Sauseng, St. Radegrund (AT); Eduard Rauch, St. Margarethen (AT); Hannes Stelzer, Lannach (AT)

(21) Appl. No.: 16/340,001

(22) PCT Filed: Oct. 6, 2017
(86) PCT No.: PCT/AT2017/060258

§ 371 Date: Apr. 5, 2019

(30) Foreign Application Priority Data
Oct. 7, 2016 (AT) A 50910/2016

(51) Int. Cl. A21C 7/00; A21C 5/04; G01F 11/02

(52) U.S. Cl. CPC A21C 7/005; A23V 2002/00; G01F 11/021; A21C 5/04

(57) ABSTRACT

A method for weighing and transporting dough includes a weighing device having a weighing pusher which can be moved back and forth controllably in an output channel. A dough drum can be rotated or pivoted around its axis, having at least one receiving chamber for receiving dough and, in each receiving chamber, a weighing pad linearly guided in the receiving chamber in the radial direction of the dough drum and adjusted in the receiving chamber by an adjusting device. A kneading drum has a number of kneading chambers distributed uniformly around the periphery of the kneading drum.

### TECHNICAL FIELD

The present teaching relates to a method for weighing and transporting, as well as a dough drum for portioning dough.

### BACKGROUND

The prior art includes various known methods and devices, also known as dough portioning machines, which portion out a specified dough weight from a dough mass using the volume method. Devices known in the prior art thus usually employ dough drums, which comprise a number of portioning pistons, into which dough is pressed and accordingly portioned. The portioning pistons, also called weighing pads, are controlled by means of control curve lever systems or mechanical systems. The disadvantage of systems known in the prior art consists in the fact that the processes to be controlled are defined mechanical elements and thus the time frame of the movement of the weighing pad can be modified only partly or not at all. This results in restrictions of the weight range of the weighed doughs, a restriction of the usable dough varieties and thus of the production capacity.

### SUMMARY

It is therefore one object of the present teaching to create a method of the aforementioned type, which makes it possible to process a great variety of doughs and dough volumes.

This object is achieved by the defining features of the present teaching. It is thereby foreseen that the adjusting device includes at least one linear drive, which controllably adjusts a number of weighing pads, in particular all weighing pads, simultaneously and uniformly, such that the lifting and/or the adjusting speed and/or the adjusting point in time of the weighing pads is controlled by the adjusting device and is modified depending on the qualities of the dough or on a stored supply.

By using a linear drive to adjust the weighing pad, it is possible to modify the control times as well as the adjusting speeds of the weighing pad or the weighing pads by adjusting the kinematics of the movement of the linear drive. Thus, for example by raising the height of the weighing pad, a greater volume can be inserted in the receiving chamber and thus it is possible to modify the dough volume or dough weight portioned out into the dough drum or measured out from the weighing device. In addition, the flexible adjustment of the linear drive makes it possible to predetermine varying, complex movement models of the weighing pad, so that low-impact processing of a great range of doughs and dough weights becomes possible.

The inventive method can be further improved in that, in the transport step during the pivoting of the dough drum, the weighing pad is controllably drawn into the transfer region and the volume in the receiving chamber is increased in order to reduce the dough weight or dough pressure.

Relieving the dough after the weighing step or in the transport step makes it possible to prevent the dough, in particular dough of a strong, expansive type, from welling up out of the receiving chamber and lets it assume its original inner pressure level. Particularly with doughs with low density, for example with large pores or a stronger expansion behavior, the pressure relief prevents strong adhesion of dough on the weighing pad and in addition makes low-impact processing of the dough possible.

The character of the dough can also be advantageously influenced in that, in the weighing step, depending on the dough consistency and/or the firmness of the dough, the weighing pad can be diverted into the receiving chamber before the weighing of the dough or in that the dough is pressed against the weighing pad by means of the weighing pusher and the weighing pad is then shifted simultaneously with the weighing pusher.

By moving the weighing pad ahead of the filling process, the structure is protected above all from soft and sensitive doughs, thus yielding optimal dough quality as a further consequence. With firmer doughs, such as lye-baked goods or doughs that require pressure, it becomes possible that, first, the weighing pusher presses the dough against the weighing pad, thus generating a predetermined pressure or pressing the dough inward, and then the weighing pad is moved synchronously with the pushing motion, so that a constantly uniform pressure is generated on the dough. This, in turn, makes it possible to retain the desired quality of the dough and guarantees a high degree of weight precision in dough pieces weighed in this manner.

To push the dough out of the receiving chamber, depending on the dimension of the weighing pads, it is advantageous if the discharge step begins earlier, during the transport step, such that the time of starting and/or the duration of the discharge step is selected depending on the dimension of the weighing pads, such that with weighing pads with large diameters the discharge step is started later, in particular with the dough drum at a greater pivoting angle, and occurs with the weighing pad at a high adjustment speed, and/or such that in weighing pads with small diameters the discharge step is started earlier, in particular with the dough drum at a smaller pivoting angle, and occurs at a lesser adjustment speed of the weighing pad.

It is also an object of the present teaching to provide a dough drum of the aforementioned type, with which a great range of different doughs can be portioned or processed and which thus requires a low equipment expenditure.

This object is fulfilled by means of the defining features of the present teaching. It is thereby foreseen that the adjusting device includes at least one linear drive, with which a predetermined number of weighing pads, in particular all weighing pads, can be controllably shifted simultaneously and/or uniformly into the respective receiving chamber, such that the lifting and/or the speed of motion and/or the time of motion of the weighing pad can be adjusted controllably by the linear drive.

Because a linear drive is built into the dough drum, it is possible to vary the control times or the lifting of the weighing pads and, depending on the work step in which the dough drum happens then to be involved, to adjust them to the requirements of the dough. It is further possible, because of the adjustable control kinematics of the linear drive, to achieve various portioning methods and processing steps and thus to process a great range of doughs without being required to re-equip the machine. In addition, the pressure in the receiving chamber can be adjusted, depending on the requirement of the dough, by a corresponding adjustment of the weighing pads by the linear drive.

Especially advantageous embodiments of the device are defined in greater detail by the features of the present teaching.

It is advantageous for the adjusting device to include at least one portioning strip, which is adjustably mounted in the dough drum by the linear drive, such that the portioning strip is configured in such a way that the weighing pads can be aligned with the portioning strip, in particular contiguous with it, or can be impacted by it with force transmission, so that upon moving the portioning strips the weighing pads are shifted as defined into the reception chambers.

Several or all of the weighing pads can be shifted simultaneously by the portioning strip, so that a unified adjustment profile of the weighing pads can be generated. In addition, the portioning strip makes it possible to vary the number as well as the portioning or dimension of the weighing pads without the need to exchange the adjustment device or parts of the adjustment device.

An advantageous embodiment foresees that the linear drive includes an electro-mechanical drive, in particular with position sensing, and at least one actuator, which can be adjusted with a number of the weighing pads, in particular by the portioning strip, such that by means of the actuator the rotating motion of the electro-mechanical drive can be converted to a linear motion.

Here it is advantageous to foresee that the actuator is configured as a spindle drive, lift-crank, toggle, hydraulic cylinder or pneumatic cylinder.

To be able to use a number of different weighing pads, it is foreseen that the dough drum includes at least one exchange strip, which can be removably inserted or plugged into the housing, such that the receiving chambers are positioned in the exchange strip for the dough portions that are to be portioned.

In an advantageous embodiment, it is foreseen that the adjusting device includes one linear drive per weighing pad, such that every weighing pad, in particular all weighing pads, can be controllably adjusted simultaneously and/or uniformly in the respective receiving chambers by the respective linear drive, such that the rising motion and/or adjustment speed and/or the adjustment time point of the weighing pads can be controllably adjusted by the respective linear drive.

By using an exchange strip it is possible in a simple manner to exchange the weighing pads inserted in the exchange strip or the reception chambers of the exchange strip, in that the exchange strip is removed from the housing and another exchange strip, for example with a different pad distribution or other pad sizes, is replaced in it.

An advantageous use of the inventive device foresees that a device includes a weighing device with a weighing pusher, which can be controllably moved back and forth in an output channel, and an inventive dough drum that can pivot or rotate around its axis.

Additional advantages and configurations of the present teaching can be seen from the description in the attached drawings.

### BRIEF DESCRIPTION OF THE DRAWINGS

The present teaching is schematically depicted hereinafter with reference to the particularly advantageous embodiments, which however are not to be considered restrictive, in the drawings and it is described by way of example with reference to the drawings, which are as follows:

FIG. 1 shows a section view of an inventive dough drum.

FIG. 2 shows an inventive device with weighing device, dough drum and kneading drum in sectional view.

FIGS. 3 through 8 show a preferred embodiment of the inventive method.

### DETAILED DESCRIPTION

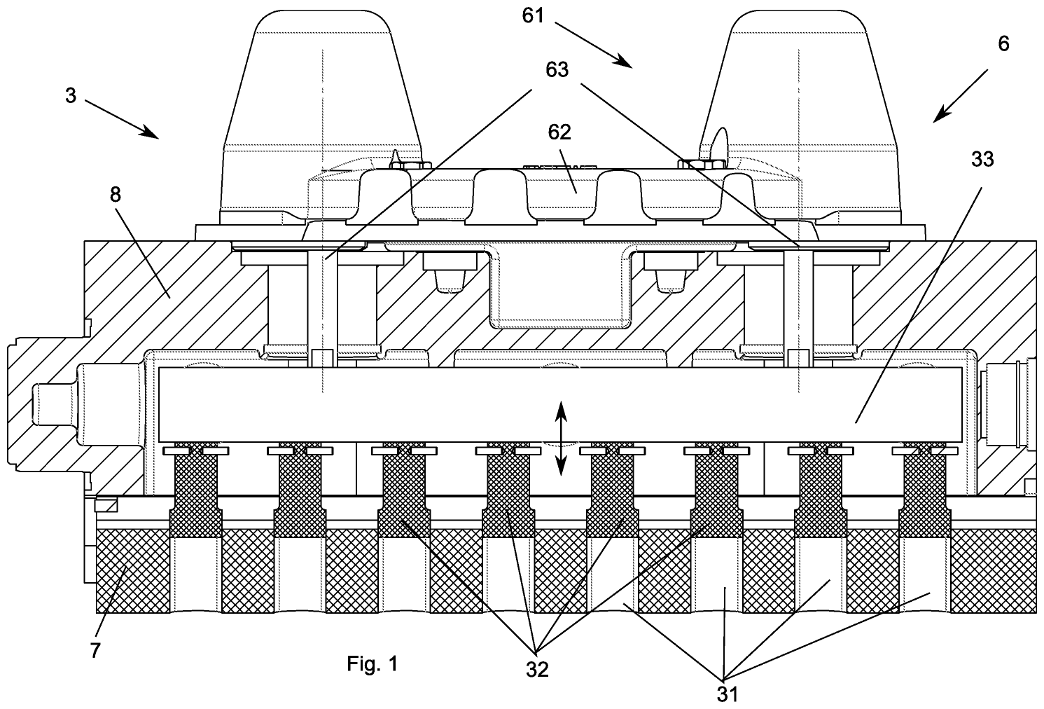

Shown in FIG. 1 is an inventive dough drum 3 for portioning dough in a section view, with the section executed along the width of the dough drum 3. The dough drum 3 includes a housing 8, which is configured in the shape of a drum. The dough drum 3, in addition, comprises eight receiving chambers 31, which extend in radial direction around the dough drum 3. One weighing pad 32 is mounted in each receiving chamber 31 and is linearly guided in the receiving chambers 31. The weighing pads 32 can be shifted linearly in the receiving chambers 31 in radial direction around the dough drum 3. As shown in FIG. 1, the weighing pads 32, upon shifting of the adjusting device 6 in the direction of the interior of the dough drum 3, free a space in the receiving chambers 31, into which dough can be moved. The weighing pads 32 are thus mounted on an adjusting device 6, with which the weighing pads 32 can be adjusted in the radial direction around the dough drum 3. The adjusting device 6 comprises a linear drive 61, with which the weighing pads 32, in this embodiment all weighing pads 32, are adjusted. The weighing pads 32 can be controllably adjusted in the respective receiving chambers 31 simultaneously and uniformly by means of the linear drive 61. The lifting of the weighing pads 32 and/or the adjustment speed and/or the adjustment time point of the weighing pads 32 can thus be controllably adjusted by the linear drive 61 and can be adjusted corresponding to the required process parameters. As depicted in FIG. 1, the adjusting device 6 can optionally include a portioning strip 33, which can be shifted by means of the linear drive 61. The portioning strip 33 is configured as a prism, and the weighing pads 32 are mounted directly contiguous with the portioning strip 33, so that the shifting of the portioning strip 33 by means of the linear drive 61 or the adjustment device 6 leads to an adjustment of the weighing pads 32 in the receiving chambers 31.

The weighing pads 32 can be contiguous with the portioning strip 33, or can be applied on it or connected with it. For example, the weighing pad 32 can be contiguous with the portioning strip 33 when dough is pressed into the receiving chamber 31.

The linear drive 61, this embodiment, comprises an electro-mechanical drive 62, which comprises a positioning sensor. In addition, the linear drive 61 comprises two actuators 63, which are configured as spindle drives. The electro-mechanical drive 62, which, for example, is an electrical motor, in each case propels a nut of the spindle drive or of the actuators 63, and thus in each case the spindle of the spindle drive is moved linearly. The spindles of the spindle drive or of the actuators 63 are connected with the portioning strip 33, and thus the shifting of the spindles of the actuators 63 leads to a linear motion of the portioning strip 33 along the motion directions depicted in FIG. 1 by the double arrow. The rotating motion of the electro-mechanical propulsion 62 is converted into a translational or linear motion by means of the actuators 63, such as for instance the spindle drives in the embodiment depicted in FIG. 1.

As illustrated in FIG. 1, the dough drum 3 can optionally include an exchange strip 7, which can be removably inserted or plugged into the housing 8. The exchange strip 7 thus comprises a number of receiving chambers 31, which are disposed, in particular flush behind one another, in the exchange strip 7. Thanks to the use or provision of an exchange strip 7, it becomes easy to exchange the weighing pads 32, which are mounted in the receiving chambers 31, by inserting corresponding exchange strips 7, each with different-sized weighing pads 32 or receiving chambers 31 different sizes, in the housing 8. Optionally, it is possible to move the weighing pads 32 also by other linear drives known from the prior art, such as linear motors, hydraulics or pneumatic cylinders, or the adjusting device 6 can include such linear drives. Another alternative is that the adjusting device 6 includes rotating drives that convert rotational movements into a linear adjustment motion, such as crank arm or toggle system, toothed racks and the like.

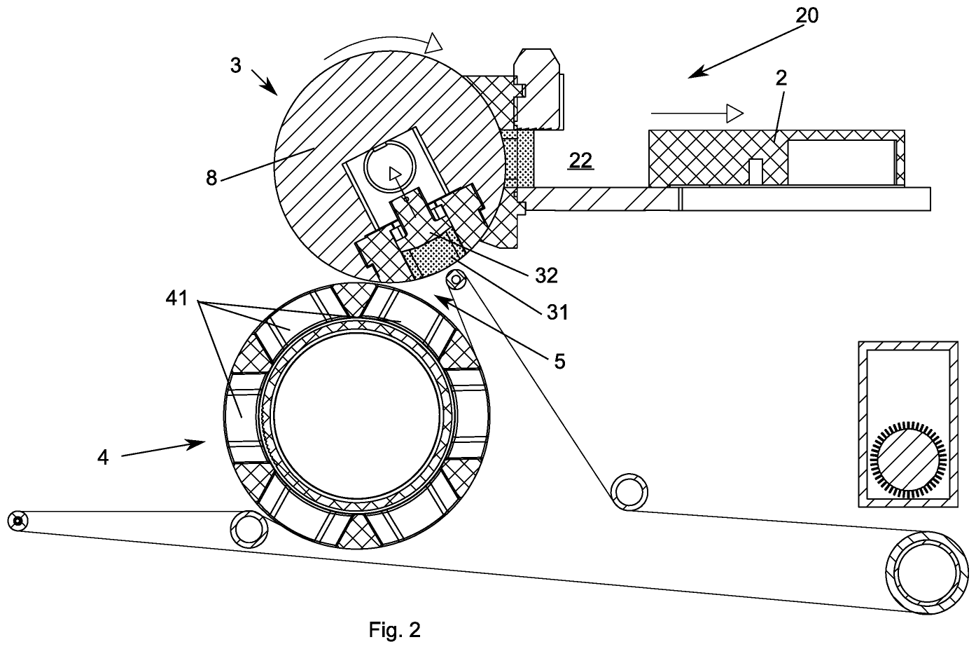

FIG. 2 shows an inventive dough drum 3 in a device for portioning and processing dough in sections. The device comprises a weighing apparatus 20, which includes a weighing pusher 2, which is movable linearly forward and backward in an output channel 31. In addition, a kneading drum 4 is foreseen, which comprises a number of kneading chambers 41, which are distributed uniformly around the periphery of the kneading drum 4. The dough drum 3 is positioned with respect to the kneading drum 4 in such a way that dough introduced into the receiving chambers 31 of the dough drum 3 can be transferred in a transfer region 5 from the receiving chamber 31 of the dough drum 3 into the kneading chambers 41 of the kneading drum 4. The dough drum 3 and kneading drum 4 are each rotatable or pivotable on their axis, so that the receiving chambers 31 can be positioned opposite the kneading chamber 41.

An inventive method is described hereinafter with reference to a preferred embodiment.

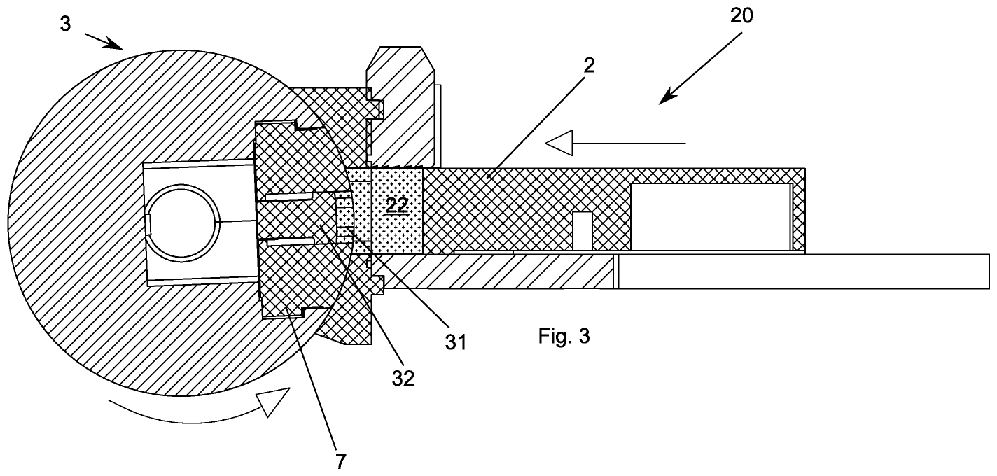

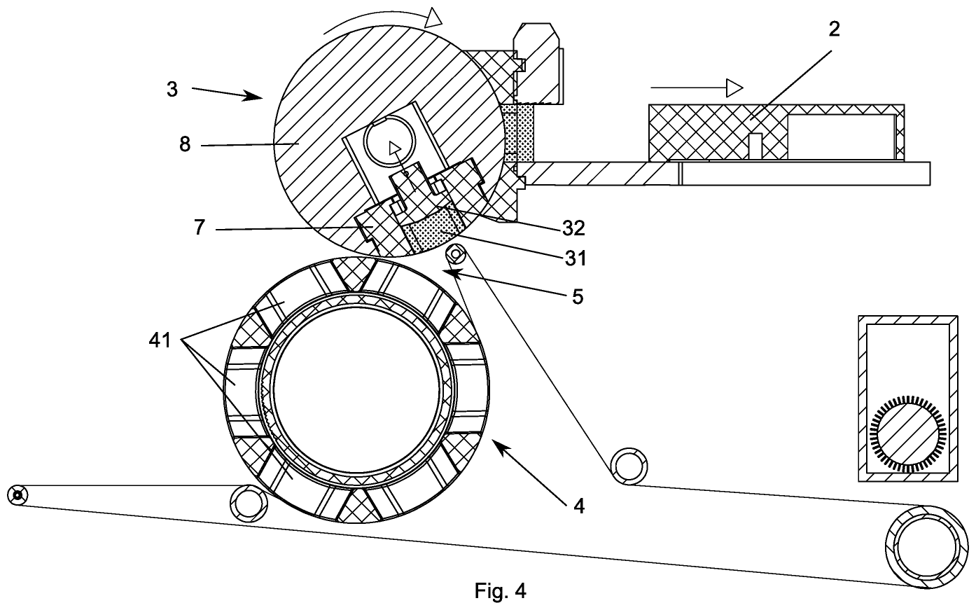

As depicted in FIG. 3, in a weighing step, by means of the weighing pusher 2, dough is removed from the weighing device 20 via the output channel 22. In the weighing step the dough drum 3 is positioned with respect to the weighing device 20 in such a way that the receiving chamber 31 points in the direction of the output channel 22 of the weighing device 20. The weighing pad 32 is moved in the receiving chamber 31 by means of the adjusting device 6 or the linear drive 61, and thus a space is cleared for the dough. The weighing pusher 2 then presses the dough situated in the output channel 22 into the space cleared by the weighing pad 32 in the receiving chamber 31, so that a portioned volume of the dough defined by the position of the weighing pad 32 is delivered into the receiving chamber 31. As a result of the radial motion of the weighing pad 32, by means of the linear drive 61 or of the adjusting mechanism 6, a defined dough amount is weighed out of the output channel 22 of the weighing device 20 in this manner. After reaching the predetermined filling volume or filling pressure of the dough in the receiving chamber 31, the weighing pusher 2 is stopped and the dough drum 3, in a transport step (FIG. 4), pivots or rotates clockwise in this embodiment. In the transport step the dough drum 3 is pivoted with the receiving chamber 31 or the receiving chambers 31 into the transfer region 5 and the respective receiving chamber 31 filled with dough is positioned in such a way with respect to one of the kneading chambers 41 of the kneading drum 4 that the dough can be transferred from the receiving chamber 31 into the respective kneading chamber 41. On reaching the transfer region 5 through the receiving chamber 31, the weighing pad 32 is moved by the linear drive 61 or the adjusting device 6 in an output step in the receiving chamber in radial direction, so that the dough is pressed out or expelled from the receiving chamber 31. Upon pushing out the dough from the receiving chamber 31, the kneading chamber 41 positioned opposite the receiving chamber 31 is filled with the dough portion that is situated in the receiving chamber 31. As a result of the linear drive 61, which simultaneously and uniformly moves the weighing pad 32, or in this embodiment all weighing pads 32, it is possible to modify controllably the height and/or the adjustment speed and/or the adjustment time of the weighing pads 32, depending on the characteristic of the dough or based on a template stored in the control unit of the linear unit 61. In this way, for example by modifying the height of the weighing pad 32 by means of the linear drive 61, the dough volume weighed out by the weighing pusher 2 in the receiving chamber 31 can be modified and thus preset.

Optionally, with the inventive method, the weighing pad 32 or all weighing pads 32 in the transport step can optionally be moved into the transfer region during the pivoting of the dough drum 3, that is, shifted in the direction of the center of the dough drum 3, and thus the volume in the receiving chamber 31 is increased and thus the dough weight or the pressure acting on the dough in the receiving chamber 31 can be reduced. More space is allowed to the dough because of the withdrawal motion of the weighing pad 32 and, for example, expansive doughs, which tend to expand out of the weighing device 20 after the weighing process, can continue to be held in the receiving chamber 31 without oozing or extending out of it completely or partly. This causes optimal pressure distribution in the weighed dough and so has a positive influence on the quality of the dough.

In addition, in the weighing step, the position of the weighing pad 32 can be altered, depending on the dough consistency and/or the dough firmness. Thus, for example, it is possible to foresee that, even before the weighing step or the weighing lift of the weighing pusher 2, the weighing pad 32 has been shifted in the direction of the center of the dough drum 3 and thus the volume to be weighed out is released in the receiving chamber 31 before the filling process or weighing step. This causes, for example, optimal quality of doughs, which in this manner are subjected only to minor weighing pressure. Alternatively, it is possible to arrange that the weighing pad 32 is completely or partly extended only in the weighing step; that is, at the start of the weighing step it leaves no free space in the receiving chamber 31. If, thereafter, the weighing pusher 2 is shifted in the release channel 22 in the direction of the receiving chamber 31 and thus impacts the dough, this causes counterpressure on the dough, so that constant pressure can be exerted on the dough. Only after reaching a predetermined dough pressure is the weighing pad 32, corresponding to the preselected weighing volume or weighing pressure, then shifted in the direction of the center of the dough drum 3 by the adjusting device 6 or linear drive 61, and thus little by little the space in the receiving chamber 31 is cleared for the dough, which is pressed into the receiving chamber 31 by means of the weighing pusher 2. This optional step makes it possible to keep the dough under constant pressure, leading to a better quality, for example with firm doughs such as with lye-baked goods, and good weight precision in weighed-out dough portions.

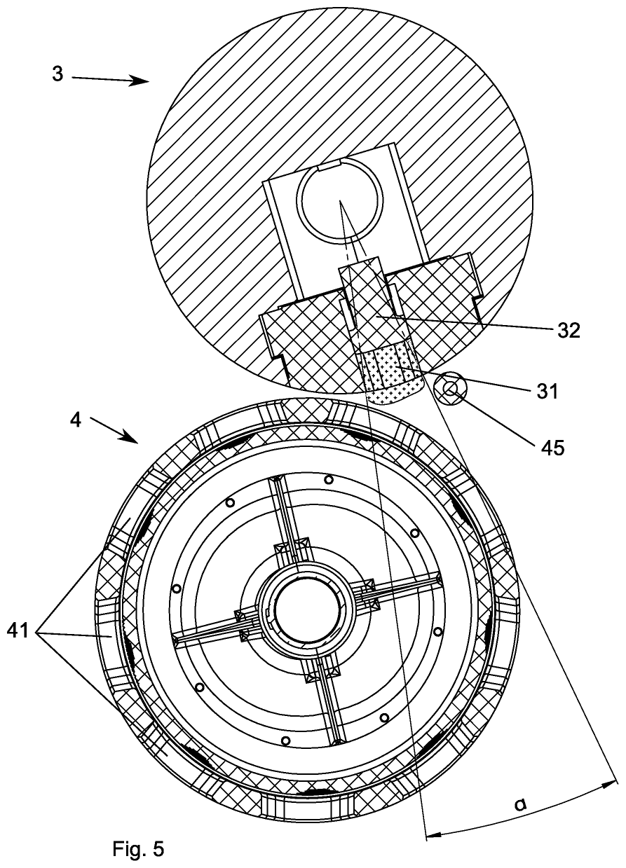

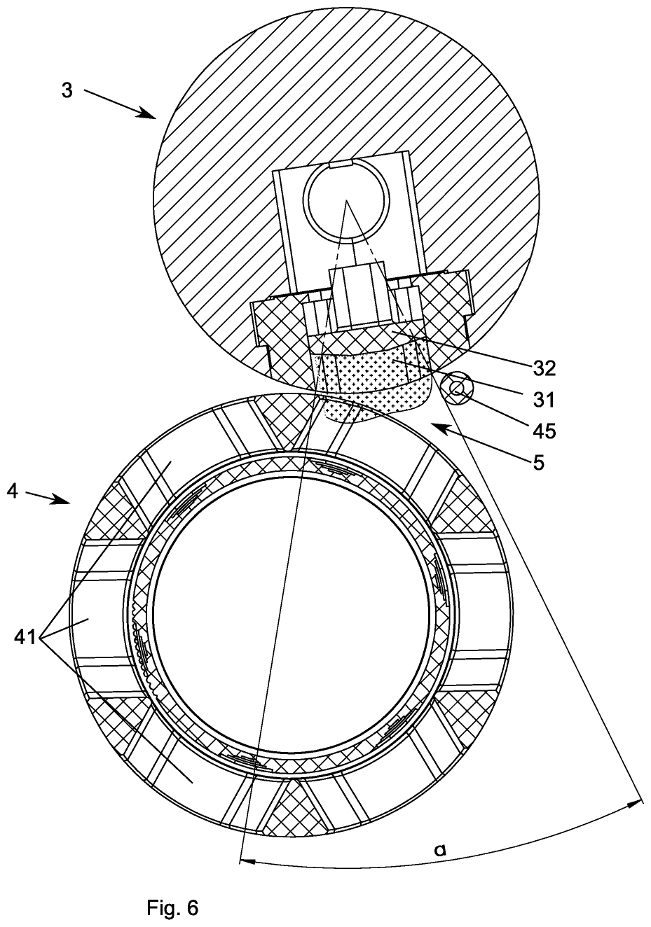

In addition, with the inventive method it is possible to foresee that the discharge step begins even during the transport step. As illustrated in FIGS. 5 and 6, pressure can thus be exerted on the dough, depending on the dimension of the weighing pad 32 at various shifting angles a, and the discharge step can be started. Thus, for example, with small weighing pads (FIG. 5), the discharge step can begin early at low shifting angles or pivoting angles a of the dough drum 3, because the cross-section of the receiving chambers 31 or weighing pads 32 have already passed any obstacles such as deflection rollers 45. Thus, with weighing pads 32 with small diameters, the discharge step can begin earlier than with weighing pads 32 with large diameters (FIG. 6).

Likewise, depending on the dimension of the weighing pad 32 or of the weighed-out dough amount, the end of the discharge step can be modified according to the required adjustment speed of the weighing pad 32 or the characteristics of the doughs. As a result of the flexible setting of the discharge speed or discharge time, a number of different weighing pads 32 can be operated with the same adjusting device or portioning strip 33, and thus the variability of the dough drum 3 or of the inventive method is increased. Thus, for example, with one and the same dough drum 3, depending on the need of individual production times, the discharge speed in the discharge step can be modified in order to transfer dough optimally from the receiving chambers 31 into the kneading chambers 41. In addition, the adjustment of individual process parameters is not coupled with mechanical elements and thus can be selected with one and the same adjusting device 6 or with the linear drive 61, as needed.

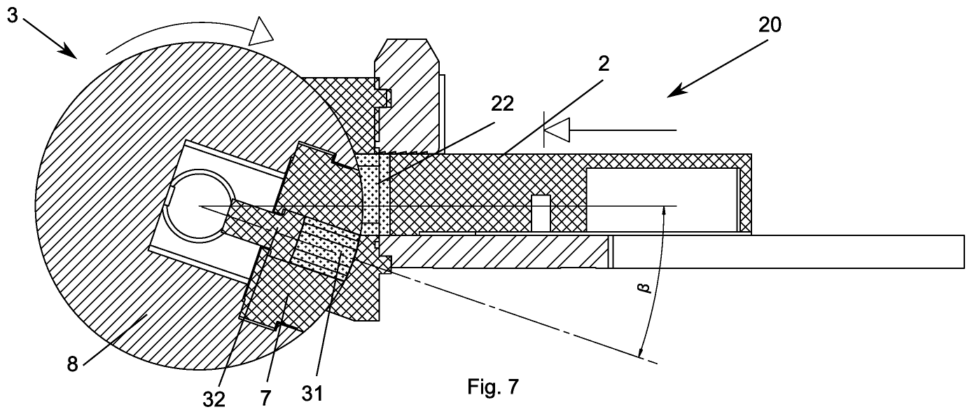

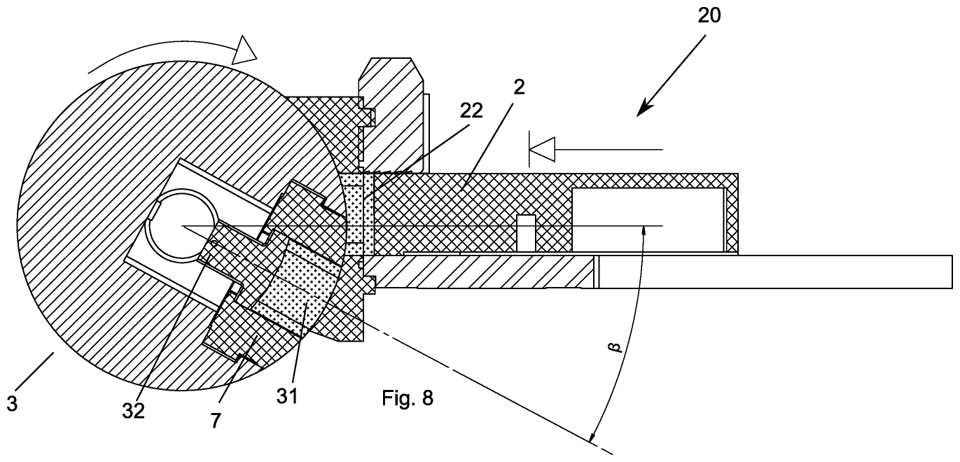

As shown in FIGS. 7 and 8, the withdrawal motion of the weighing pads 32 during the transport step can be adjusted to the diameter of the weighing pads 32. Thus, for example, as shown in FIG. 7, with small weighing pads 32 the withdrawal process can begin earlier, because the receiving chamber 31 no longer corresponds with the output chamber 22 of the weighing device 20 at low rotating angles 13. With larger weighing pads 32, as depicted in FIG. 8, the time of the withdrawal motion of the weighing pad 32 in proportion to small weighing pads 32 can be selected differently, so that even with variation the pad's diameter can be ensured, since with the withdrawal motion no dough is pulled from the weighing pad 32 into the receiving chamber 31.

Thus, as a result of the inventive dough drum 3, depending on the characteristics of the dough, whether it is of a high specific or low specific weight, has a high degree of swelling, or is a firmer or more liquid dough, the process parameters in every single step of the weighing process are adjusted to the requirements of the dough and thereby the highest quality is assured during the entire weighing and treatment process of the dough.

Alternatively it can be foreseen that the dough drum 3 also comprises several exchange strips 7 distributed around the periphery and thereby, during rotation of the dough drum 3 around its own axis, several receiving chambers 31, each arranged behind one another along the exchange strip 7, can be brought into correspondence with the weighing device 20 or the kneading chambers 41 of the kneading drum 4. It can likewise be foreseen that, as shown in FIGS. 1 through 8, the dough drum 3 is configured as a so-called dough apportioning drum, such that in each case it includes only one exchange strip 7, which can be inserted or plugged into the housing 8 of the dough drum 3. An exchange strip 7 of this type can thus comprise one or more, or a whole number, of receiving chambers 31, which advantageously are arranged flush, one behind the other linearly along the exchange strip 7. The receiving chambers 31 of the respective exchange strip 7 can thus be configured as equal in size and in each case the same kind of weighing pads 32 can be mounted in each receiving chamber 31.

In the case of alternative embodiments that are not illustrated, it is foreseen that the adjusting device 6 includes one linear drive 61 for each weighing pad 32. The linear drives 61 thus shift one of the weighing pads 32 and can be adjusted synchronously by means of a control unit. Alternatively, in addition, it can be foreseen that the weighing pads 32 each comprise differences in dimension and that for each dimension of the weighing pads 32 one linear drive 61 is foreseen, so that the individual shifting motions of the weighing pads 32 or the varying dimensions of the weighing pads 32 can be controllably adjusted in various ways.

1. A method for weighing and transporting dough, having a device that includes:
a weighing device with a weighing pusher, which can be controllably moved back and forth in an output channel,
a dough drum, which can pivot or rotate around its own axis, and which comprises at least one receiving chamber to receive dough and, in each receiving chamber, a weighing pad that is linearly directed in the receiving chamber in the radial direction of the dough drum and is shifted by an adjusting device in the receiving chamber, and
a kneading drum with a number of kneading chambers distributed uniformly around the periphery of the kneading drum,
such that in a weighing step a), a defined dough volume is weighed out and/or pressed in along the output channel into at least one receiving chamber by means of the weighing pusher, such that the weighed-out dough volume is predetermined and preset by means of radial shifting of the weighing pad,
such that in a transport step b) after reaching the preset filling volume and/or filling pressure in the receiving chamber the weighing pusher is stopped and the dough drum is pivoted into a transfer region until the respective receiving chamber filled with dough is positioned opposite one of the kneading chambers, so that the dough can be transferred out of the receiving chamber into the respective kneading chamber, and
such that the weighing pad is shifted in the receiving chamber in a discharge step c) in such a way that the dough is pushed out of the receiving chamber and transferred to the kneading chamber,
wherein the adjusting device includes at least one linear drive, which controllably shifts at least one weighing pad, in particular all weighing pads, simultaneously and uniformly, such that the lift height and/or the adjustment speed and/or the adjustment time of the weighing pads is controlled and modified by the adjusting device depending on the characteristics of the dough or according to a template.

2. The method according to claim 1, wherein in the transport step b), during the pivoting of the dough drum, the weighing pad is controllably drawn into the discharge region and the volume in the receiving chamber is increased in order to reduce the dough load and/or dough pressure.

3. The method according to claim 1, wherein in the weighing step a), depending on the dough consistency and/or the dough firmness, before the weighing of the dough, the weighing pads are drawn into the receiving chambers or the dough is pressed against the weighing pads by means of the weighing pusher and the weighing pads then are shifted simultaneously with the weighing pusher.

4. The method according to claim 1, wherein the discharge step c) begins even during the transport step b), such that the starting time and/or the duration of the discharge step c) is adjusted depending on the dimension of the weighing pads,
such that, with weighing pads of large diameters, the discharge step c) is started later, in particular according to a larger pivoting angle of the dough drum and occurs at a high adjusting speed of the weighing pads and/or
such that, with weighing pads of small diameters, the discharge step c) is started earlier, in particular at a smaller pivoting angle of the dough drum, and occurs at a lower adjustment speed of the weighing pad.

5. A dough drum for portioning dough according to claim 1, said drum being rotatable or pivotable in steps by a propulsion, including a housing,
such that the dough drum includes a number of receiving chambers for the dough portions that are to be measured out, and which in particular are distributed uniformly around the periphery,
such that in at least one of the receiving chambers, a weighing drum is linearly directed and is slidably mounted by an adjusting device in the receiving chamber in the radial direction of the dough drum, and
such that the weighing pads are positioned in the dough drum in such a way that, upon sliding the weighing pads, dough can be introduced into the receiving chamber,
wherein the adjusting device includes at least one linear drive, by which a preset number of weighing pads can controllably be shifted simultaneously and/or uniformly in the respective receiving chambers, such that the lift height and/or the adjustment speed and/or the adjustment time of the weighing pads can be controllably shifted by the linear drive.

6. The dough drum according to claim 5, wherein the adjusting device includes at least one portioning strip, which is adjustably positioned in the dough drum by the linear drive,
such that the portioning stripe is configured in such a way that the weighing pads can impact the portioning strip by touching it, being brought contiguous with it or by being force transmitting, so that upon shifting the portioning strip the weighing pads are shifted in defined manner in the receiving chambers.

7. The dough drum according to claim 5, wherein the linear drive includes an electro-mechanical propulsion, and at least one actuator by which a number of weighing pads can be shifted, such that the rotational motion of the electro-mechanical propulsion can be converted into a linear motion by means of the actuator.

8. The dough drum according to claim 7, wherein the actuator is configured as a spindle drive, lift-crank, toggle, hydraulic cylinder or pneumatic cylinder.

9. The dough drum according to claim 5, wherein the dough drum includes at least one exchange strip, which can be removably inserted or plugged into the housin4,
such that the receiving chambers for the dough portions that are to be portioned are positioned in the exchange strip.

10. The dough drum according to claim 5, wherein each adjusting device includes one linear drive per weighing drum, such that every weighing pad can be controllably shifted simultaneously and/or uniformly by the respective linear drive in the respective receiving chambers, such that the lift and/or the adjustment speed and/or the adjustment time of the weighing pad can be controllably shifted by the respective linear drive.

11. A device for performing the method according to claim 1, including a weighing device with a weighing pusher, which can be controllably moved back and forth in an output channel and a dough drum which can pivot or rotate around its axis.
